(19) United States
(12) Patent Application Publication
(10) Pub. No.: US 2019/0262823 A1
(43) Pub. Date: Aug. 29, 2019

(54) A STERILE CONTAINER FOR PROCESSING A MIXTURE SEPARABLE INTO LAYERS IN A CLOSED CIRCUIT, AND A RELATIVE METHOD

(71) Applicant: NCS LAB S.R.L., CARPI (IT)

(72) Inventors: MATTEO MANTOVANI, CARPI (IT); DANIELE VENUTA, PORTILE (IT)

(21) Appl. No.: 16/308,368

(22) PCT Filed: Jun. 8, 2017
(86) PCT No.: PCT/IB2017/053396

§ 371 Date: Dec. 7, 2018

(30) Foreign Application Priority Data
Jun. 10, 2016 (IT) 102016000059601

(51) Int. Cl. B01L 3/00

(52) U.S. Cl. CPC B01L 3/5021; B01L 2200/026; B01L 2400/0605; B01L 2300/049; B01L 2300/123; B01L 2300/048

(57) ABSTRACT

A sterile container for processing in a closed circuit a mixture separable into layers, comprises a chamber for containing a mixture separable into layers, a first connector for coupling to an injection device and/or a removing device, the latter for removal of a layer of a multi-layer mixture. connector enables a fluid connection between the chamber and the injection device and/or the removing device. A first conduit, inside the chamber, is dimensioned to enable removal of the first layer. The container includes a second connector for coupling with the injection device and enabling fluid connection between the chamber and the injection device. The second connector is conformed for coupling also to the removing device. A second conduit inside the chamber is dimensioned to enable removal of a second layer of the multi-layer mixture.

### FIELD OF THE INVENTION

The present invention relates to, the technical sector relating to processing in a closed circuit of a mixture separable into layers. In particular, the present invention relates to a sterile container for processing a mixture separable into layers in a closed circuit, and a relative method.

### DESCRIPTION OF THE PRIOR ART

A mixture separable into layers is constituted by a plurality of components which can be solid, liquid or gaseous. The mixtures are subdivided into homogeneous mixtures, constituted by a single phase, and heterogeneous mixtures, which are constituted by two or more steps and wherein the components are easily distinguishable from one another.

With the aim of analysing a particular component of a mixture, it is common practice to proceed to the separation of the mixture into layers and removal of the layer of interest.

For example, supposing a mixture is heterogeneous, constituted by a liquid solution and bacteria, and subjected to centrifugation, a first layer will be obtained comprising the bacteria as well as a second layer, arranged above the first layer, comprising the liquid solution; to proceed with a bacteriological analysis the first layer will then be removed.

At present, in order to separate a mixture into layers and, for removing the layer of interest, the mixture is arranged internally of sterile test tubes under vacuum.

The sterile test tubes under vacuum comprise: a chamber under vacuum for containing the mixture separable into layers; a first opening for placing the chamber in communication with the outside; a silicone membrane arranged at the first opening for sealedly closing and ensuring the vacuum internally of the chamber.

With the aim of injecting the mixture separable into layers into the above-mentioned known test tube, it is necessary to insert a needle, connected to a tank of mixture separable into layers, internally of the chamber, piercing the silicone membrane: the vacuum inside the chamber will suck the mixture separable into layers from the tank. Once the mixture separable into layers is arranged in the known test tube, it is separated into layers (for example by centrifugation) and subsequently, using a syringe with a relative needle, the layer of interest is removed: the needle is inserted into the chamber, newly piercing the silicone membrane, and the layer of interest is removed.

However, the insertion of the needles into the sterile test tube can lead to contamination of the mixture.

Further, the use of needles is potentially dangerous for the operator; supposing that the mixture comprises bacteria, the operator might enter into contact with the needle and become infected.

### SUMMARY OF THE INVENTION

In the light of the above, the aim of the present invention consists in obviating the above-mentioned drawbacks.

The above aims are attained with a sterile container for processing a mixture separable into layers in a closed circuit according to claim 1 and a relative method according to claim 3.

The sterile container of the invention, as well as the method of the invention, advantageously enables processing, in a closed circuit, a mixture separable into layers without the use of needles.

With particular reference to the method of the present invention, in fact, with the aim of injecting a mixture separable into layers into the sterile container of the invention, it is necessary to connect to the container an injection device of a mixture separable into layers (for example a syringe lacking a needle) and to inject into the chamber a mixture separable into layers: because of the presence of the first connector and the first valve it is not necessary to use any needle.

Likewise, following the separation of the mixture separated into layers, to remove the first layer of the mixture it is necessary to connect to the container a removing device of a layer of a mixture separated into layers (for example, a syringe lacking a needle) and to remove the first layer of the mixture separated into layers: thanks to the first connector and the first valve it is not necessary to use any needle, not even during the removal step.

The sterile container of the invention enables processing in a closed circuit a mixture separable into layers without the use of needles.

This advantageously reduces the risks for the operator and the probability of contaminating the mixture separable into layers contained in the chamber.

Further, the presence of the second conduit enables being able to remove, from the container, a plurality of layers of the mixture separated into layers, also starting from the layer arranged superiorly. In this way the probability of causing an undesired mixing of the mixture separated into layers is advantageously minimized.

### BRIEF DESCRIPTION OF THE DRAWINGS

Specific embodiments of the invention will be described in the following of the present description, according to what is set down in the claims and with the aid of the accompanying tables of drawings, in which:

FIG. 1 is a perspective view of the sterile container of the present invention;

FIGS. 2 and 3 are two respective lateral views of the sterile container of FIG. 1;

FIGS. 4 and 5 are two respective views from above of the sterile container of FIG. 1;

FIG. 6 illustrates the sterile container of FIG. 4 along section IX-IX;

FIG. 7 illustrates the sterile container of FIG. 5 along section X-X;

FIG. 8 illustrates, by way of example, a system for closed circuit, processing of a mixture separable into layers which uses a sterile container, object of the present invention.

### DESCRIPTION OF THE PREFERRED EMBODIMENTS

With reference to the appended tables of drawings, reference numeral (1) generically denotes a sterile container, for closed circuit processing of a mixture separable into layers, object of the present invention.

The sterile container (1) can be a test tube or a vial.

A mixture separable into layers is constituted by a plurality of components which can be solid, liquid or gaseous. The sterile container (1) of the present invention is particularly suitable for heterogeneous mixtures which are separable into layers by mechanical separation.

An example of a mixture separable into layers can be blood or a liquid solution in which bacteria or other cells are suspended.

In the following of the present description, the terminology “sterile container (1) for closed circuit processing” is taken to mean that the sterile container (1) is suitable for enabling processing of a mixture separable into layers with no contact with the air, i.e. in sterile conditions and with no risk of contamination of the mixture. In any case, the collecting of a layer of the mixture separated into layers is preferably carried out in laminar flow conditions (i.e. under a fume hood).

The term “processing” a sterile mixture separable into layers is taken to mean, for example, the operations of insertion of a mixture separable into layers internally of the sterile container (1), separation into layers of the mixture separable into layers and removal of the at least a first layer of the mixture separated into layers.

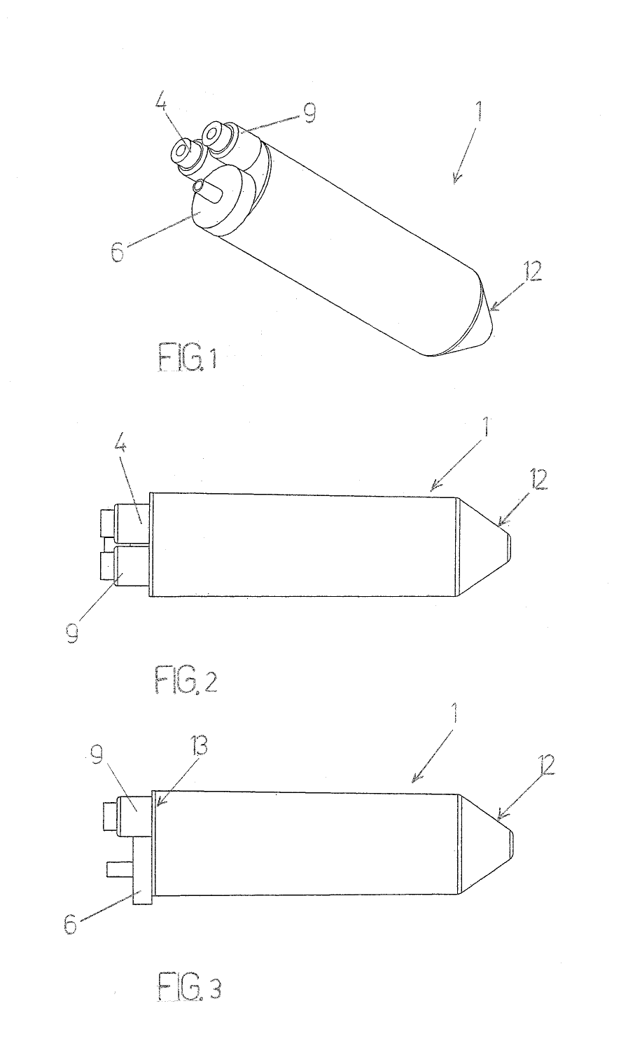

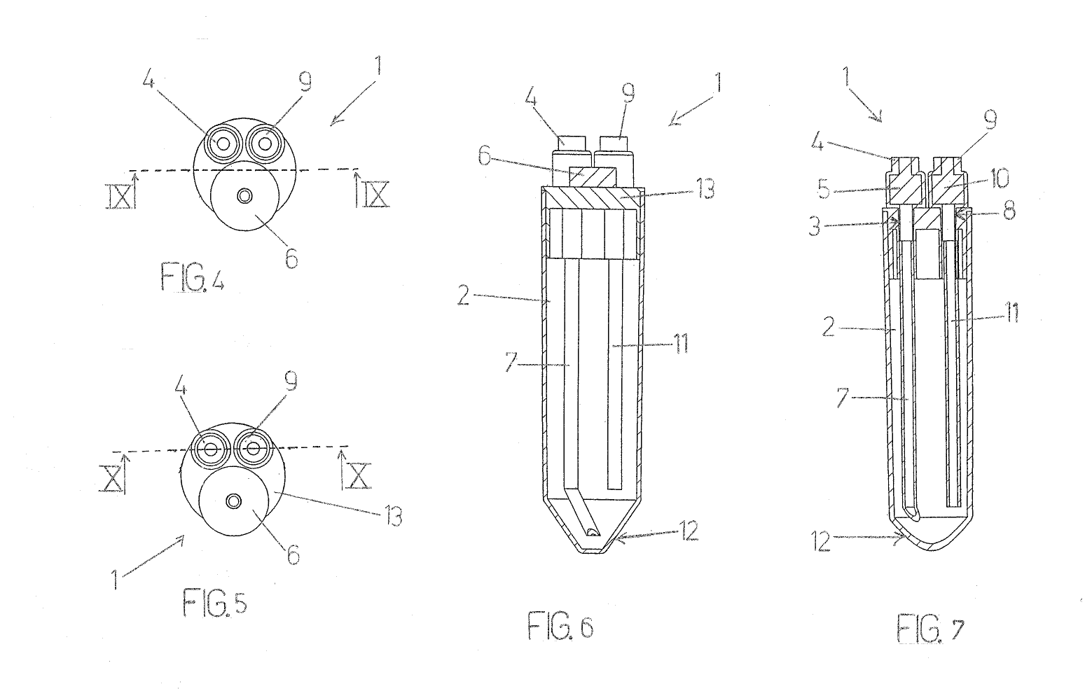

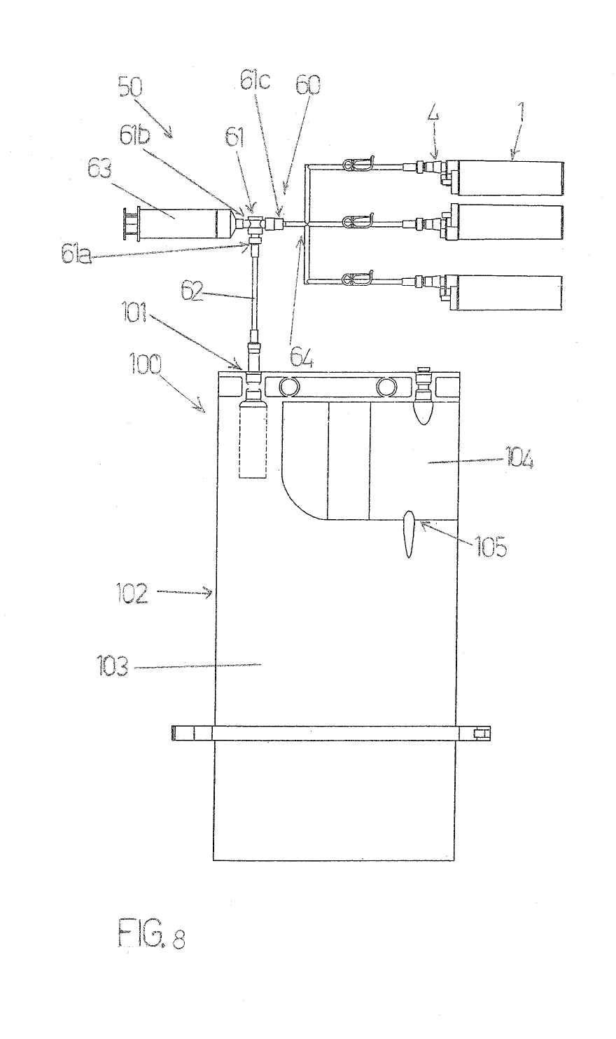

With reference to the appended figures of the drawings, in particular FIGS. 1-7, the sterile container (1) of the present invention comprises a chamber (2) for containing a mixture separable into layers which mixture is separable into at least a first layer and a second layer, and a first opening (3) for placing the chamber (2) in communication with the outside.

The sterile container (1) further comprises: a second opening (not illustrated) for placing the chamber (2) in communication with the outside; a first connector (4) conformed for coupling to an injection device (for example a syringe lacking a needle), for injection of a mixture separable into layers, and/or a removing device (for example a syringe lacking a needle) for removal of a layer of a mixture separated into layers.

The first connector (4) is arranged and conformed for enabling the fluid connection, via the first opening (3), between the chamber (2) and the injection device and/or the removing device.

The sterile container (1) further comprises: a first valve (5) conformed for sealedly closing the first opening (3); a second valve (6) arranged and conformed for enabling exit of air from the chamber (2), when the mixture separable into layers is injected into the chamber (2); a first conduit (7) which is arranged internally of the chamber (2), which is connected to the first opening (3) and which is dimensioned so as to enable the removal of the first layer of the mixture separated into layers.

In particular, the first valve (5) can assume a closed configuration in which it sealedly closes the first opening (3) and an open configuration in which is placed in fluid communication, through the first opening (3), the chamber (2) and the first connector (4).

Thus, the first valve (5) connects the first connector (4) and the first opening (3). In particular, the first valve (5) can be arranged at the first opening (3).

The first valve (5) can be a double-acting valve. The first valve (5) can comprise a deformable body, for example made of silicone, having a through-hole.

In particular, the first valve (5) is conformed so as assume the open configuration when the injection device is connected to the first connector (4): the connection of the injection device to the first connector (4) determines the deformation of the deformable body of the first valve (5) enabling inlet into the chamber (2) of the mixture separable into layers.

Thereafter, by disconnecting the injection device from the first connector (4) the first valve (5) returns into the closed configuration, i.e., the deformable body of the first valve (5) will return into the starting condition, preventing the outflow of mixture separable into layers from the chamber (2). Following the separation into layers of the mixture separable into layers, by connecting the removing device to the first connector (4) the first valve (5) will assume the open configuration, enabling removal of the first layer of the mixture separated into layers. When the removal is complete, the removing device is disconnected from the first connector (4) and the first valve (5) returns into the starting condition, i.e. closed configuration.

The second valve (6) is preferably a double-acting valve so as to enable exit of air from the chamber (2), when the mixture separable into layers is injected into the chamber (2), and the inlet of air into the chamber (2), when the first layer of the mixture separated into layers is removed from the chamber (2) (usually the step of removing the layer of the mixture separated into layers is carried out in laminar flow conditions i.e. under a fume hood).

The second valve (6) does not enable outflow from the chamber (2) of the mixture separable into layers and/or the layers of the mixture separated into layers.

The first connector (4) can also be conformed for coupling to the removing device and the sterile container (1), further comprises: a third opening (8) for placing for placing the chamber (2) in communication with the outside; a second connector (9) arranged and conformed for coupling to the injection device and for enabling fluid connection, via the third opening (8), between the chamber (2) and the injection device; a third valve (10) conformed for sealedly closing the third opening (8).

By way of example, the first connector (4) can be conformed for coupling only to the removing device while the second connector (9) can be conformed for coupling only to the injection device.

In particular, the third valve (10) can assume a closed configuration in which it sealedly closes the third opening (8) and an open configuration in which it places in fluid communication, through the third opening (8), the chamber (2) and the second connector (9).

Thus, the third valve (10) connects the second connector (9) and the third opening (8). In particular, the third valve (10) can be arranged at the third opening (8).

In this case the first valve (5) and the third valve (10) can be single-acting valves.

The first valve (5) can comprise a deformable body, for example made of silicone, having a through-hole, and the third valve (10) can comprise a deformable body, for example made of silicone, having a through-hole.

With the sterile container (1) of the present invention, by connecting the injection device to the second connector (9) the third valve (10) will assume the open configuration, i.e. the deformable body of the third valve (10) will tend to deform and widen the through-hole, enabling inlet into the chamber (2) of the mixture separable into layers. When the injection of the mixture separable into layers into the chamber (2) is completed, the injection device is disconnected from the second connector (9) and the deformable body of the first valve (10) returns into the starting condition, preventing the outflow of mixture separable into layers from the chamber (2) (the third valve (10) will return into the closed configuration). Following the separation into layers of the mixture separable into layers, by connecting the removing device to the first connector (4) the first valve (5) will assume the open configuration, i.e. the deformable body of the first valve (5) will tend to deform, widening the through-hole and enabling outflow of the first layer of the mixture separated into layers from the chamber (2). Lastly, by disconnecting the removing device from the first connector (4) there will be a return of the first valve (5) into the closed configuration.

The sterile container (1) can comprise a cap (not illustrated) for sealing the exposed end of the first connector (4), when the removing device and/or the injection device is not connected to the first connector (4).

Still with particular reference to FIGS. 1-7, the second connector (9) is conformed for coupling also to the removing device and wherein the container comprises a second conduit (11) which is arranged internally of the chamber (2), which is connected to the third opening (8) and which is dimensioned so as to enable the removal of the second layer of the mixture separated into layers.

Therefore, the second connector (9), like the first connector (4), can couple both to the injection device and to the removing device: for example, the first connector (4) and the second connector (9) can be conformed for coupling both to respective removal devices for collecting, once the mixture separable into layers is injected into the chamber (2), a plurality of layers of the mixture separated into layers. Further, the presence of the second conduit (11) enables being able to remove, from the container, a plurality of layers of the mixture separated into layers, also starting from the layer arranged superiorly. In this way the probability of causing an undesired mixing of the mixture separated into layers is advantageously minimised.

The sterile container (1) can comprise a main body which forms the chamber (2). The main body can be made of rigid PVC. Further, the main body can be conformed as a vial or a test tube.

The sterile container (1) can comprise a bottom wall (12) and an upper wall (13) opposite the bottom wall (12). The first opening (3) and the third opening (8) are preferably made at the upper wall (13).

After the mixture has been separated into layers, it is advantageously simpler not to cause an undesired mixing.

Further, the first conduit (7) can be longer than the second conduit (11).

In this way, supposing that the second layer is arranged above the first layer, it will be possible first to remove the second layer by means of the second conduit (11) and then the first layer by means of the first conduit (7). This advantageously enables removing the layers while reducing to a minimum the undesired mixing between the layers themselves.

The first conduit (7) preferably has an end (7a) in proximity of the bottom wall (12). This advantageously ensures removal of all the inferiorly-arranged layer.

Supposing that the mixture separable into layers is a heterogeneous mixture constituted by a liquid solution and bacteria, following the separation into layers, the bacteria will deposit on the bottom, constituting the first layer. The end, of the first conduit (7) in proximity of the bottom will thus advantageously ensure removal of a sufficient quantity of bacteria.

The first connector (4) and the second connector (9) can be identical. Likewise, the first valve (5) and the third valve (5) can be identical.

The following contains a method for processing, in a closed circuit, a mixture separable into layers, object of the present invention.

The method comprises steps of: providing a sterile container (1) according to the sterile container (1) of the present invention; connecting to the container an injection device of a mixture separable into layers (for example a syringe lacking a needle); injecting a mixture separable into layers into the chamber (2); separating the mixture separable into layers into the at least a first layer and a second layer, the second layer being arranged above the first layer; connecting to the first connector (4) a removing device of a layer of a mixture separated into layers (for example, a syringe lacking a needle); connecting to the second connector (9) a removing device of a layer of a mixture separated into layers (for example, a syringe lacking a needle); removing the second layer of the mixture separated into layers by means of the second connector (9) and the second conduit (11); removing the first layer of the mixture separated into layers by means of the first connector (4) and the first conduit (7).

The method of the invention advantageously enables processing in a closed circuit a mixture separable into layers without the use of needles.

The method advantageously enables removing, from the sterile container (1), the first layer and the second layer, minimising the risk of an undesired mixing between them.

The mixture separable into layers is preferably mechanically injected under pressure into the chamber (2) (for example, using a syringe lacking a needle). Further, the first layer can be removed from the chamber (2) by mechanical aspiration (for example using a syringe lacking a needle).

The first valve (5) can advantageously be constituted by a simple deformable body, for example made of silicone.

Likewise, the second layer can also be removed from the chamber (2) by mechanical aspiration. The second valve (6) can also advantageously be constituted by a simple deformable body, for example made of silicone.

The mixture separable into layers is separated into the at least a first layer and second layer by mechanical separation, for example by centrifugation or precipitation.

With reference to FIG. 8, a system (50) is illustrated for processing, in a closed circuit, a mixture separable into layers which uses a sterile container (1), object of the present invention.

It is supposed that a patient has a prosthesis removed due to an infection. With the purpose of better assessing the entity of the infection and understanding which antibiotic to use to treat the patient, it is necessary to analyse the bacteria present on the prosthesis. For this reason it is necessary to remove a sufficient quantity of bacteria from the removed prosthesis without contaminating them, i.e. ensuring during the whole processing step to act in closed circuit conditions.

The system (50) illustrated in FIG. 8 comprises: a closed circuit sterile device (100) used for collection, transport and processing of a removed infected prosthesis, which sterile device (100) comprises an outlet (101) of a mixture separable into layers; at least a sterile container (1) of the present invention; closed circuit connection means (60) for connecting the outlet (101) of the sterile device (100) to the container.

The sterile device (100) is known and described in detail in patent application PCT/IT2015/000140. It comprises a bag (102) which forms a first chamber (103) internally of which the removed prosthesis (not illustrated) is arranged, and a second chamber (104) containing a washing solution. The first chamber (103) and the second chamber (104) are separate from one another; they are placed in fluid communication by opening a passage (105) closed by a breakable valve.

In particular, after having arranged the removed prosthesis in the first chamber (103) of the bag (102), said first chamber (103) is sealedly closed, the passage (105) is opened and the first chamber (103) and the second chamber (104) are placed in fluid communication. The washing solution thus strikes prosthesis and “collects” the bacteria contained thereon, leading to the formation of the mixture separable into layers.

The connection means (60) of the system (50) comprises: a three-way valve (61) comprising a first inlet (61a), a second inlet (61b) and a first outlet (61c); a first conduit (62) which places the outlet (101) of the sterile device (100) and the first inlet (61a) of the three-way valve (61) in fluid connection; a syringe lacking a needle (63) in fluid connection with the second inlet (61b) of the three-way valve (61); a second conduit (64) which places the outlet (61c) of the three-way valve (61) in fluid connection with the first connector (4) of the sterile container (1).

In particular, the three-way valve (61) is designed so that the aspiration by the syringe lacking a needle (63) takes the mixture separable into layers from the first chamber (103) of the bag (102) to inside the syringe lacking a needle (63) and so that the thrust of the syringe lacking a needle (63) pushes the mixture separable into layers from the syringe lacking a needle (63) up to the chamber (2) of the sterile container (1) (passing through the first opening (3)).

Thus, in an absolutely-closed circuit, the sterile container (1) is filled with mixture separable into layers.

At this point, the sterile container (1) is detached from the system (50) (in particular from the second conduit (64) of the connection means (60)) and the mixture in layers can be separated.

Thereafter, as mentioned the foregoing, by connecting a removing device to the first connector (4) (or possibly to the second connector (9)), the first layer and/or the second layer can be removed.

1. A sterile container for processing in a closed circuit a mixture separable into layers, comprising:
a chamber for containing a mixture separable into layers which mixture is separable into at least a first layer and a second layer;
a first opening for placing the chamber in communication with an outside;
a second opening for placing the chamber in communication with an outside;
a first connector conformed for coupling with an injection device, for injection of a mixture separable into layers, and/or with a removing device, for removal of a layer of a mixture separated into layers;
wherein the first connector is arranged and conformed for enabling the fluid connection, via the first opening, between the chamber and the injection device and/or the removing device;
a first valve conformed for sealedly closing the first opening;
a second valve arranged and conformed for enabling exit of air from the chamber, when the mixture separable into layers is injected into the chamber;
a first conduit which is arranged internally of the chamber, which is connected to the first opening and which is dimensioned so as to enable the removal of the first layer of the mixture separated into layers;
wherein the first connector is conformed for coupling to the removing device, the sterile container further comprising:
third opening for placing the chamber in communication with an outside;
a second connector arranged and conformed for coupling to the injection device and for enabling fluid connection, via the third opening, between the chamber and the injection device;
third valve conformed for sealedly closing the third opening;
wherein
the second connector is conformed for coupling also to the removing device and wherein the container comprises a second conduit which is arranged internally of the chamber, which is connected to the third opening and which is dimensioned so as to enable the removal of the second layer of the mixture separated into layers;
further comprising:
a bottom wall and an upper wall opposite the bottom wall;
the first opening and the third opening being fashioned in the upper wall;
the first conduit being longer than the second conduit.

2. The sterile container of claim 1, wherein the first conduit has an end in proximity of the bottom wall.

3. A method for processing in a closed circuit a mixture separable into layers, comprising steps of:
providing a sterile container according to claim 1;
connecting to the sterile container an injection device of a mixture separable into layers;
injecting a mixture separable into layers into the chamber;
separating the mixture separable into layers into the at least a first layer and a second layer, the second layer being arranged above the first layer;
connecting to the first connector a removing device of a layer of a mixture separated into layers;
connecting to the second connector a removing device of a layer of a mixture separated into layers;
removing the second layer of the mixture separated into layers by means of the second connector and the second conduit;
removing the first layer of the mixture separated into layers by means of the first connector and the first conduit.

4. The method of claim 3, wherein the mixture separable into layers is mechanically injected under pressure into the chamber and wherein the first layer is removed from the chamber by mechanical aspiration.

5. The method of claim 3, wherein the mixture separable into layers is separated into the at least a first layer and second layer by mechanical separation.

6. The method of claim 4, wherein the mixture separable into layers is separated into the at least a first layer and second layer by mechanical separation.
